(19) United States
(12) Patent Application Publication
(10) Pub. No.: US 2010/0220670 A1
(43) Pub. Date: Sep. 2, 2010

(54) Method for Scheduling to Reduce Inter-Cell Interference for Voice Communication in OFDMA

(76) Inventors: Koon Hoo Teo, Lexington, MA (US); Serhan Yarkan, Tampa, FL (US); Jinyun Zhang, Cambridge, MA (US); Man-On Pun, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/395,204

(22) Filed: Feb. 27, 2009

(51) Int. Cl. H04W 72/04; H04L 27/28

(52) U.S. Cl. 370/329; 375/260

(57) ABSTRACT

A method schedules voice communication in an Orthogonal Frequency Division Multiplexing Access (OFDMA) network of base stations serving sets of mobile stations in cells. The method uses statistical characteristics of voice communications by adjusting scheduling periods accordingly to measurement reports provided by the mobile stations. The base stations generally use persistent scheduling for voice transmission due to inherent characteristics, along with extra signaling concerns. Base stations have the liberty of shortening or prolonging the scheduling period according to their needs while taking into account changes in dynamic conditions. This method makes use of the measurement reports provided by the mobile stations along with a shortened scheduling period in order to reduce ICI.

### FIELD OF THE INVENTION

This invention relates generally to wireless communication, and more particularly to managing interference in mobile cellular radio networks.

### BACKGROUND OF THE INVENTION

Orthogonal Frequency Division Multiplexing Access (OFDMA)

Orthogonal Frequency Division Multiplexing Access (OFDMA) is used in third 3rd Generation Partnership Project (3GPP) Long Term Evolution (LTE) and the Worldwide Interoperability for Microwave Access (WiMAX) networks. The available spectrum is partitioned into orthogonal subcarriers. The orthogonality among the subcarriers can reduce intra-cell interference (ICI).

Inter-Cell Interference (ICI)

In the context of OFDMA, inter-cell interference (ICI) occurs when adjacent base stations (BS) in the cells assign the same frequency to different user equipment (UE) or mobile stations (MS). The most severe ICI originates from the frequency collision on the edges of the cells. If the frequency in which BS1 communicates with MS1 on the edge in one cell is the same as the frequency in which the BS2 communicates with MS2 on the edge of an adjacent cell, then the interference has the greatest impact in both downlink and uplink directions.

Edge Region and Center Region of Cell

To avoid frequency collision, various frequency reuse schemes are known in the prior art. One of the most desired deployment options is a frequency reuse factor of one (FRO), in order to avoid resource underutilization. Along with FRO, some other schemes also partition the cell into edge and center regions.

In each cell, the bandwidth (BW) for the set of MS served by the BS can be partitioned into edge region MS and edge region BW, when available. Usually, the edge region BW takes a third of the available BW. The transmit power on each BW can be changed adaptively according to the level of interference.

### SUMMARY OF THE INVENTION

The embodiments of the invention provide a method for scheduling in Orthogonal Frequency Division Multiplexing Access (OFDMA) networks without the requirement of base station (BS) coordination.

For voice packets, the method exploits the statistical characteristics of the radio signal, such as channel holding time and scheduling period by scheduling voice transmission according to the measurement reports provided by a mobile station (MS).

For voice packets, one of the most important aspects is the deterministic structure in terms of packet generation, which is generally 20 ms. This is equivalent the length of the frames constructed by voice coders.

Furthermore, it is known that voice conversations are statistically characterized as negative exponential, which implies the property of being memoryless. This is very important for the design of schedulers.

In addition, because voice transmission requires only a small amount of resources (both in time and frequency), resources can be assigned less frequently compared to data and multimedia traffic. Thus, the scheduling period can be reduced or prolonging accordingly the impact on the expected number of collisions. This is done by having scheduling periods (intervals) T1 and T2. Reducing the period of scheduling also reduces the expected number of collisions at the cost of more frequent scheduling. This can be done unilaterally at the BS, and does not require any backhaul information exchange.

In case of having a fixed expected number of collision value, depending on the status of neighboring cell, which can be measured through the ICI reports, scheduling period can be prolonged to utilize the resources, and reduce the cost for frequent scheduling. Thus, the BS can apply persistent scheduling for voice transmission due to inherent characteristics, along with extra signaling concerns. The BS can increase or decrease the scheduling period according to need, while taking into account dynamic conditions of the network. The BS can also make use of the feedback reports provided by the MS to reduce resource collisions.

### BRIEF DESCRIPTION OF THE DRAWINGS

FIG. 1 a schematics of a two arrangements of cellular networks requiring inter-cell-Interference scheduling for voice communications in OFDMA network according to embodiments of the invention; and

FIG. 2 is a flowchart of a method for scheduling voice communications in the network of FIG. 1.

### DETAILED DESCRIPTION OF THE EMBODIMENTS OF THE INVENTION

Network

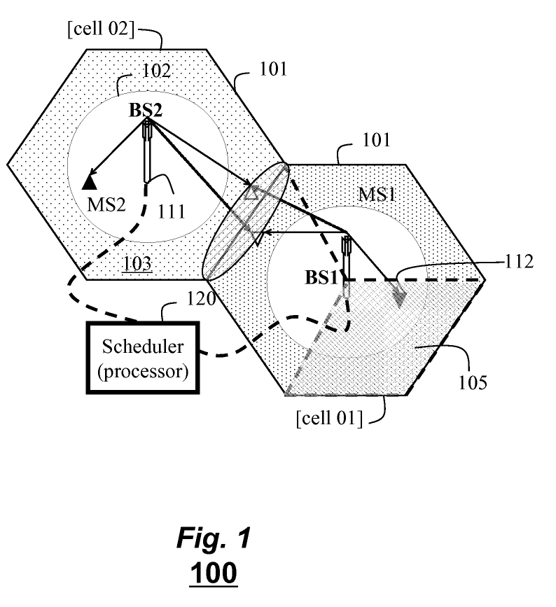

As shown in FIG. 1, a wireless cellular network, according to embodiments of the invention, includes base stations (BSs) 111, or eNode-B, and mobile stations (MS) 112 arranged in cells, [cell 01 and cell 02], 101. The network also includes a scheduler 120, as described herein. The secular includes a processor for performing steps of a method for scheduling resources according to the embodiments of the invention. The scheduler can be in BS 111 or an infrastructure backbone or network interface.

The cell can be partitioned into an interior region (IZ) 102 and an edge region (EZ) 103. Inter-cell interference (ICI) scheduling mainly focuses on the MS in the edge regions 103. Resources can be partitioned according to the regions. By using antenna arrays, each cell can also be partitioned into sectors 105, e.g., three sectors.

Physical Resource Block (PRB) or Radio Resource Block (RRB)

The radio resources in an Orthogonal Frequency Division Multiplexing Access (OFDMA) network include frequency, time and space. The resource element considered in the invention is a physical resource block (PRB), which spans both the frequency (subcarriers) and time domain (symbols). The PRB is also known as the Radio Resource Block (RRB). The component frequencies of one PRB can be either contiguous or disjoint. The time duration of the PRB is defined by Transmission Time Interval (TTI). By reusing the PRB among cells or sectors of cells, frequency division, time division and spatial division are achievable.

Inter-Cell Interference Scheduler

An ICI scheduler, which can be in a mobile switching center, in a centralized network, or in BSs in non-centralized and/or ad hoc networks, which assign the resources to the MS dynamically. The scheduler takes into account the two aspects of the resources, frequency and time. Frequency aspect corresponds to the mapping of frequencies to be assigned and selection of appropriate MS, whereas time denotes the scheduling period.

Scheduling Period

The scheduling period is a time duration during which the assigned frequencies are maintained for the MS. Peculiar to voice communications, due to its inherent characteristics, the schedulers assign the MS the resources and maintain the assignment until either the communication ends, or a new assignment is required. In OFDMA-based systems, scheduling period can be increased or decreased if it is needed.

Measurement Reports

In next generation wireless mobile cellular radio networks, frequency re-use of one (FRO) can increase the capacity of the network, and avoid an expensive frequency planning process. This approach raises serious concerns regarding the determination of interference conditions of MS because of universal frequency usage. Hence, the network needs to know vulnerable MS, and some MS may need to report measurements on ICI. Depending on the aggregated measurement reports, networks take appropriate action in terms of scheduling, managing the resources.

If each MS in the network reports its own measurement regardless of any constraint, the reporting process can increase signaling overhead. Thus, it is important for the network to decide whether the MS needs to report its measurement, or not. For convenience, the terms interference zone (IZ), and safe zone (SZ) are defined.

Inter-Cell Interference Scheduling Without the Requirement of Coordination

For example, [cell 01] decreases its scheduling period, because [cell 02] uses persistent scheduling and does not want to change the period. In addition, [cell 01] uses measurement reports.

For the frequency aspect of scheduling, scheduler reserves a set of resources for MSs in the center region, while reserving the remainder for the MSs in the cell edge region. When partitioning of the resources is done, the scheduler determines the resources that are assigned and unassigned for both cell center and cell edge regions. Unassigned resources can be merged to form a single set of resources, or the resources can be kept as two separate sets. Unassigned resources can be assigned to other MS in different regions of the cell, when necessary, which forms a resource borrowing scheme.

Next, the scheduler in [cell 01] partitions its scheduling period into two or more intervals. For example, the scheduler partitions the scheduling period T into subperiods T1 and T2. During subperiod T1, the scheduler uses persistent scheduling until the next scheduling period T. During T1, the scheduler aggregates the reports provided by the cell edge MS.

At the beginning of subperiod T2, the scheduler evaluates the reports and assigns resources to the MS, which report ICI, from the set that contains the unused resources for the cell edge. Depending on the scheme adopted and traffic load in interior regions, unused resources are assigned to the MS reporting ICI until all of the unused resources are assigned. During subperiod T2, the last assignment is maintained, and the reports are again collected from MS for the next scheduling period.

General Method

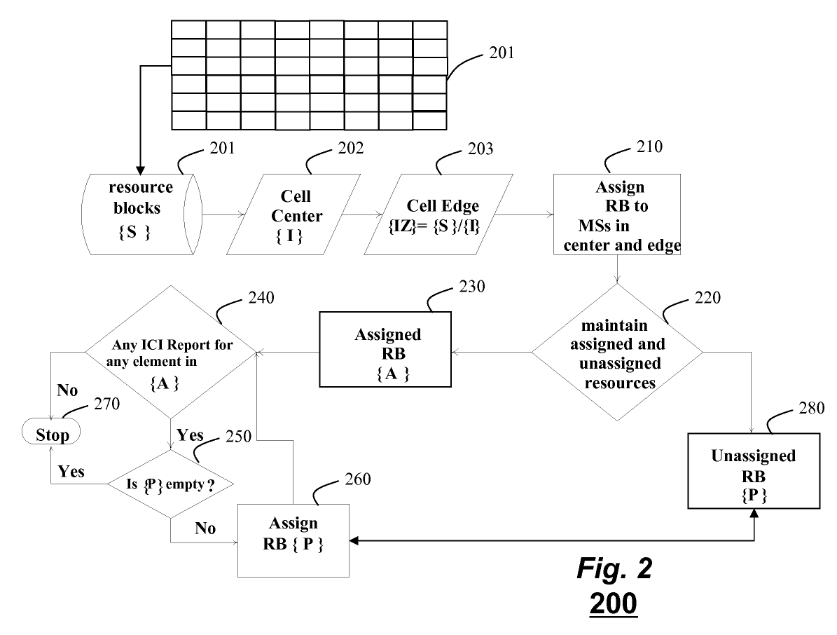

FIG. 2 a method for scheduling voice communications in the network of FIG. 1 according to embodiments of the invention. In Figure, the notation {X} is used for representing sets of elements denoted with letter X.

The scheduler 120 of FIG. 1 partitions the available radio resources, i.e., subcarriers and time into a set {S} 201 of available resource blocks (RB) 200. Each RB includes a set of (6) subcarriers and a set of (8) symbols over time, for example.

The BS assigns the set {I} of RB 102 to the MS in the center regions. The remaining set {IZ} of RB is reserves for the MS in the edge region.

Then, the BS assigns 210 the RB to the MS in the center region and the edge region. The BS maintains 220 the set {A} of assigned RB 230 and the set {P} of unassigned RB 280. This set can be maintained independently or jointly for the center and edge regions.

The scheduler determines 240 if any of the MS that have assigned resources are reporting ICI. If, not the scheduler is done 270 until the next measurement report is received.

The scheduler determines 250 if the set {P} is empty, and if so, there is nothing the scheduler can do until the next scheduling period.

Otherwise, the scheduler assigns 260 an appropriate resource from the set {P} 280, updates the set {P}, and repeats the steps in the next scheduling period.

When a station leaves the network, its resources are added to the set {P}.

This invention focused on the inter-cell interference between two macro-cells with overlapping interference zone. The invention can be extended to ICI between or among one or more macro cells, and one or more femto- and pico-cells. In one embodiments, the sphere of influence of one or more macro-cells may cover the whole femto- or/and pico-cell(s). In other words, the interference zone in this case is the whole femto- or/and pico-cell(s).

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for scheduling resources in an Orthogonal Frequency Division Multiplexing Access (OFDMA) network including a set of base stations (BS) in corresponding cells, each BS serving a set of mobile stations (MS) in each cell, wherein each cell includes a center regions and an edge region, and wherein the MS communicate packets including voice data, comprising a scheduler including a processor for performing steps of the method, comprising the steps of:
partitioning, during each scheduling period, available into a set of resource block {S};
assigning a set of {I} resource blocks to the MS in the center region;
assigning a set {IZ} of the resource blocks to the MS in the edge region;
maintaining a set {P} of unassigned resources;
receiving measurements reports from the MS indicating a level of inter-cell-interference (ICI);
assigning the resource blocks from the set {P} to the MS reporting ICI if the set {P} is not empty.

2. The method of claim 1, wherein a length of the scheduling period varies dynamically according to the measurement reports.

3. The method of claim 1, wherein the maintaining and assigning for the set {P} is independent for the MS in the center region and the edge region.

4. The method of claim 1, wherein the maintaining and assigning for the set {P} is joint for the MS in the center region and the edge region.

5. The method of claim 1, wherein the period includes a subperiod for the receiving and a subperiod for the assigning.

6. The method of claim 1, wherein the RB are added to the set {P}, when the MS leave the network.

7. The method of claim 1, wherein the scheduler is part of the BS.

8. The method of claim 1, wherein each RB includes a set of subcarriers in a frequency domain, and a set of symbols in a time domain.

9. The method of claim 8, wherein the subcarriers are contiguous.

10. The method of claim 8, wherein the subcarriers are disjoint.

11. The method of claim 1, wherein the scheduling is centralized.

12. The method of claim 1, wherein the scheduling is disjoint.

13. The method of claim 1, wherein the network has a frequency re-use factor of one.

14. The method of claim 1, wherein the scheduling is persistent.
